(19) United States
(12) Patent Application Publication
(10) Pub. No.: US 2014/0069682 A1
(43) Pub. Date: Mar. 13, 2014

(54) CABLE STRUCTURES AND SYSTEMS AND METHODS FOR MAKING THE SAME

(71) Applicants: Albert J. Golko, Saratoga, CA (US); Edward Siahaan, San Francisco, CA (US); Eric S. Jol, San Jose, CA (US); John B. Ardisana, II, San Francisco, CA (US)

(72) Inventors: Albert J. Golko, Saratoga, CA (US); Edward Siahaan, San Francisco, CA (US); Eric S. Jol, San Jose, CA (US); John B. Ardisana, II, San Francisco, CA (US)

(73) Assignee: APPLE INC., Cupertino, CA (US)

(21) Appl. No.: 13/610,688

(22) Filed: Sep. 11, 2012

(51) Int. Cl. H01B 7/20; H01B 13/14

(52) U.S. Cl. 174/102 C; 156/51

(57) ABSTRACT

Cable structures for use in cable assemblies that interconnect portable electronic devices with various other devices, such as power adaptors, computers, media playback devices, etc. are shown. The cable structures can include a ground conductor that is broken up into multiple, smaller ground conductors that are physically separate and distinct from each other with the cable structure (and which can be terminated together in, for example, the connectors at the ends of the cable assembly). The cable structure may also include conductors having insulating material formed from FEP and/or wire mesh shield elements configured for high durability during bending and twisting of the assembled cable. An extrusion process can be used to manufacture the final, fully-assembled cable structure.

### BACKGROUND

Cable structures are commonly used with many portable electronic devices such as portable music players and mobile phones. Cable structures can include non-conductive components such as fillers, jackets and insulators that are combined with the conductive and shielding components to form the complete cable structures. The cable structures are often used to connect the portable electronic devices to a power source for charging or to a computer, such as an Apple Macintosh, in order to sync data between the computer and the portable device. The one or more cables can be manufactured using different approaches

### SUMMARY

Cable structures and systems and methods for manufacturing cable structures are disclosed.

A cable structure can be used to interconnect a portable electronic device to various things, such as a power adaptor for charging, a computer for syncing data or an external media system to play back content stored on the portable device. The cable structure typically undergoes a significant amount of bending, twisting and pulling throughout the useful life of the product. This occurs, at least in part, because of the portable nature of the devices the cables are used with. As such, an interconnection cable can often be wound into a tight coil and stuffed into a pocket, purse or briefcase. When needed for use, the cable is then stretched out and possibly pulled in an attempt to straighten it. This repeated coiling and straightening could lead to reliability problems.

The cable structures utilize a multi-pronged approach to achieving increased reliability, both short term and long, as well as providing cable structures that are smaller in diameter that traditional cable structures. Each cable structure includes power, signal, ground and shield conductors, as well as an external jacket. The power and signal conductor elements may be manufactured using an external covering formed from fluorinated ethylene propylene, commonly referred to as FEP, which, while being more difficult to manufacture than traditional coverings formed from polypropylene, enable the conductor elements to be closer together (in part, due to the increased insulating capabilities of the FEP). In addition, the FEP coverings can be thinner than polypropylene while still providing at least, if not better, insulation.

The cable structures may include a ground conductor that is broken into multiple, independent elements that are kept physically separate from each other in the cable structure, until they are jointly terminated in the connectors at the ends of the cable. The use of multiple, independent elements for the ground “conductor” may provide multiple benefits, including, for example, an overall smaller diameter of the cable structure, as well as a significant improvement in flexibility. While the ground “conductor” may be implemented as two or more separate, independent ground elements, it may be advantageous to utilize a ground element for each of the other conductors in the cable structure. For example, in a standard USB configuration that includes two signal conductors and a voltage bus conductor, the cable structure can include a ground “conductor” that is divided into three independent elements, such that there can be approximate symmetry in the fully assembled cable structure to improve overall reliability and durability of the cable structure.

The cable structures can also include stranded wires that are wound together instead of utilizing a solid conductor. For example, the voltage bus conductor could be made of multiple, significantly thinner strands of wire, such as 30 strands, instead of a solid conductor. The thinner strands provide better durability to the overall performance of the cable structure when compared to a solid core voltage bus conductor. Similarly, the signal wires could be constructed of thin strands of wire as well, in which case only about 18-20 strands would likely be needed (since they are signal conductors versus the voltage bus). Moreover, the use of stranded wires versus solid wires further enables the overall cable structure to be thinner and more resilient to suffering damage from repeated bending and unbending.

An addition common component in electronic cable structures that can be varied to improve reliability and durability is the contiguous wire mesh sleeve that is typically located just inside the external jacket of the cable structure. This sleeve provides overall shielding to the cable structure, as all of the conductors are located therein. One way to also improve durability of the overall cable structure to bending and twisting that commonly occurs is to change the pitch with which the wire mesh is formed. For example, many wire mesh shield components are often formed using a tight weave to insure that sufficient shielding occurs. This tight weave can have a pitch on the order of about ten degrees. By opening up the pitch to at least double that, such as on the order of twenty or twenty-five degrees, space is provided to the strands of wire that form the wire mesh sleeve so that they are less likely to rub and grind against each other as the cable structure is bent and twisted, thereby extending the durability of the cable structure. In addition, having a pitch on the order of twenty or twenty-five degrees retains the necessary shielding performance of the mesh so that electrical performance of the cable structure is not sacrificed.

### BRIEF DESCRIPTION OF THE DRAWINGS

The above and other aspects and advantages of the invention will become more apparent upon consideration of the following detailed description, taken in conjunction with accompanying drawings, in which like reference characters refer to like parts throughout, and in which:

FIG. 1 shows a cross-sectional view of a cable structure that utilizes multi-“conductor” ground components in accordance with some embodiments of the invention;

FIG. 2A is a side view of a wire mesh shield braid that may be used on conventional cable structures;

FIG. 2B is a side view of a wire mesh shield for use in cable structures in accordance with some embodiments of the invention; and

FIG. 3 is a flowchart of an illustrative process for producing cable structures in accordance with some embodiments of the invention.

### DETAILED DESCRIPTION OF THE DISCLOSURE

Cable structures for use with electronic devices are disclosed. The cable structures interconnect portable electronic devices to various items such as, for example, power adaptors, media playback devices (e.g., digital televisions, speakers, computer monitors, etc.) and computers (for data syncing, for example). The cable structures can include one or more features that enable the cable structure to perform with higher reliability and exhibit more durability over the normal useful life of the product. Moreover, many of the features described herein enable the cable structures of the present invention to be manufactured using less material and in thinner form factors than conventional cable structures.

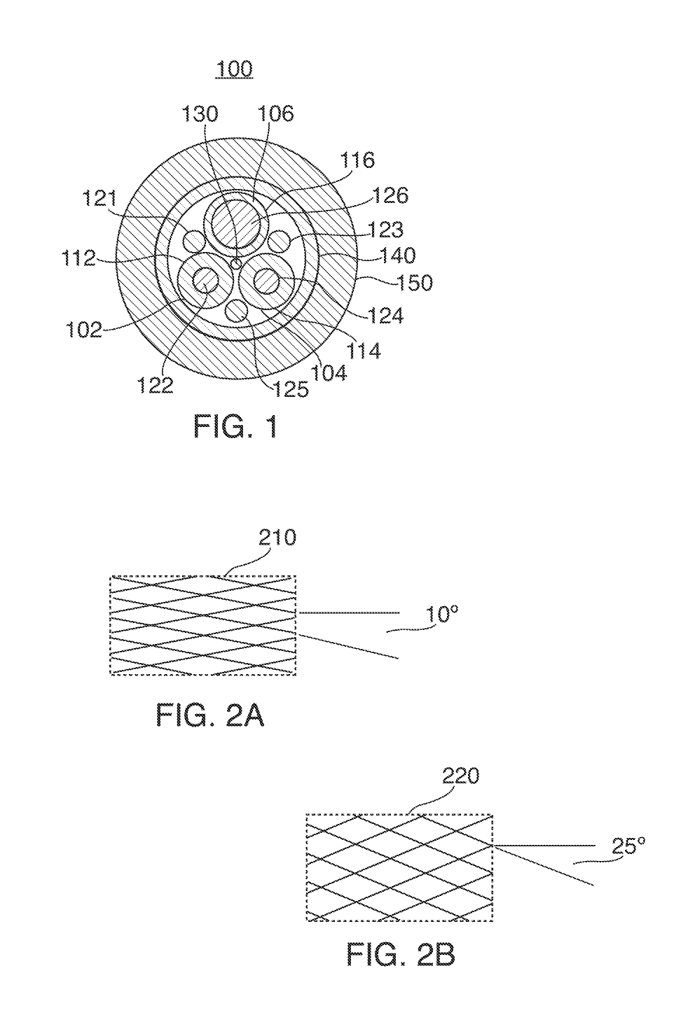

Cable structure 100 is shown in FIG. 1. Cable structure 100 includes signal conductors 102 and 104 (e.g., they may be used in a USB cable for signals D+ and D−), voltage bus (Vbus) conductor 106 and a ground “conductor.” In this instance, the ground “conductor” is actually formed from the combination of ground elements 121, 123 and 125 in accordance with at least some embodiments of the present invention. Cable structure 100 also includes filler 130 (which may, for example, be formed of a substance such as Kevlar so that it takes on at least a portion of the physical load from the conductors), which is utilized particularly during the manufacturing process in order to maintain the proper separation and alignment between each of the other components of cable structure 100. In addition, cable structure 100 also may includes a wire mesh 140 that can encapsulate and essentially completely enclose all of the previously described components therein such that wire mesh 140 can act as an overall shield to cable structure 100. All of these components are then enclosed in a jacket that can be extruded over the components using a material such as, for example, DSM arintel.

While the ground “conductor” is shown as three physically separate and unique elements 121, 123 and 125, it should be appreciated that the ground “conductor” can be formed with more or fewer elements. In fact, a single conventional conductor can be used in some embodiments of the present invention while still utilizing other features of the present invention, such as the use of fluorinated ethylene propylene (FEP) as the insulating cover on signal conductors 102 and 104 instead of polypropylene. While FEP may be more difficult to work with than polypropylene, FEP provides better shielding capability while utilizing less material. As such, the insulator itself can be thinner than a comparable polypropylene insulator, and the signal wires can be closer to each other without any significant degradation in performance (e.g., cable structures manufactured in accordance with this aspect of the present invention will still comply with the USB standard even though the conductors are closer together than typically found in conventional USB cable structures).

In another approach in accordance with the present invention, cable structure 100 could include conductors that are formed from multiple fine strands of wire that are wound together instead of the typical solid core conductors that are often found in electrical cable assemblies. The number of strands may vary based on the operational requirements of the conductor itself. For example, the Vbus conductor may be formed from roughly 30 strands of wire, while the signals conductors (assuming they are, in this instance, USB signal conductors) may be formed utilizing roughly 19 strands of wire (such that they are thinner than the Vbus conductor). This particular aspect of the present invention provides cable structure 100 with a high degree of durability when compared to conventional cable assemblies, as the conductors are less likely to deteriorate and/or fracture from the repeated bending, twisting and straightening that they are likely to undergo during the normal useful life of the cable formed from cable structure 100. In addition, a multi-stranded configuration of the conductors undergoes reduced stress as compared to conventional cable structures.

The cable structure can also include be manufactured in accordance with other aspects of the present invention by varying fabrication of the wire mesh shield components typically found in data cables. Conventional wire mesh shields typically have a dense pattern of interwoven wire strands that may have been intended to insure that the wire mesh performs adequately as a shield to the entire cable structure.

FIG. 2A, for example, shows an illustration of the weave angle for a typical conventional cable mesh shield 210 having a tight weave in which the angle is approximately 10 degrees. As can be viewed by the illustrations in FIG. 2A, the diamonds formed by weave 210 are relatively narrow and elongated. Under such circumstances, however, when the completed cable assembly is bent and/or twisted, the individual strands of mesh 210 are inclined to rub against each other since there is very little empty space in the diamonds. Over time, the strands can fray and break, which may result in a degradation of the shield performance of mesh 210.

FIG. 2B shows an illustration of a wire mesh shield component 220 constructed in accordance with at least some of the embodiments of the present invention. As shown in FIG. 2B, the individual strands of wire mesh 220 are configured to be spaced apart at least twice the angle of typical convention wire mesh shields. For example, FIG. 2B shows an angle between strands of approximately 25 degrees. The change in the angle between strands necessarily changes the configuration of the diamonds between the strands such that the amount of space in the diamond is significantly larger (see FIG. 2B). The increased space provides room for the mesh strands to move slightly without rubbing against other strands when the completed cable assembly is twisted and/or bent. Accordingly, cable structures that include such a configuration should exhibit a higher degree of durability and a longer useful life than cable structures that use more conventional spacing between mesh strands.

Cable assemblies can be manufactured using one or more features of the present invention to reduce the overall diameter of the cables, improve their flexibility and/or improve their durability and reliability, while maintaining their signal integrity. Accordingly, cable assemblies may also be manufactured utilizing each of features described herein.

Cable structure 100, for example, is shown to include at least the feature related multiple independent elements of a ground conductor, but may also include the use of FEP as an insulator on signal conductors 102 and 104, and/or the broad spread wire mesh shield described above for shield 140, and/or the use of stranded conductors for conductors 102 and 104, and/or Vbus 106. The use of all of the features described above should result in an assembled cable that is significantly thinner, more flexible, and more durable than conventional assembled cables, while still maintaining the necessary signal integrity. For example, each of these features can be implemented on a reduced diameter USB cable while still maintaining the spacing between signal lines such that the 90-ohm impedance requirement set forth in the USB specification is maintained.

Cable structures in accordance with the methods of the present invention can be constructed using many different manufacturing processes. The processes include injection molding, compression molding, and extrusion. In injection and compression molding processes, a mold is formed around a conductor bundle or a removable rod. The rod is removed after the mold is formed and a conductor bundle is threaded through the cavity. In extrusion processes, an outer shell is formed around a conductor bundle.

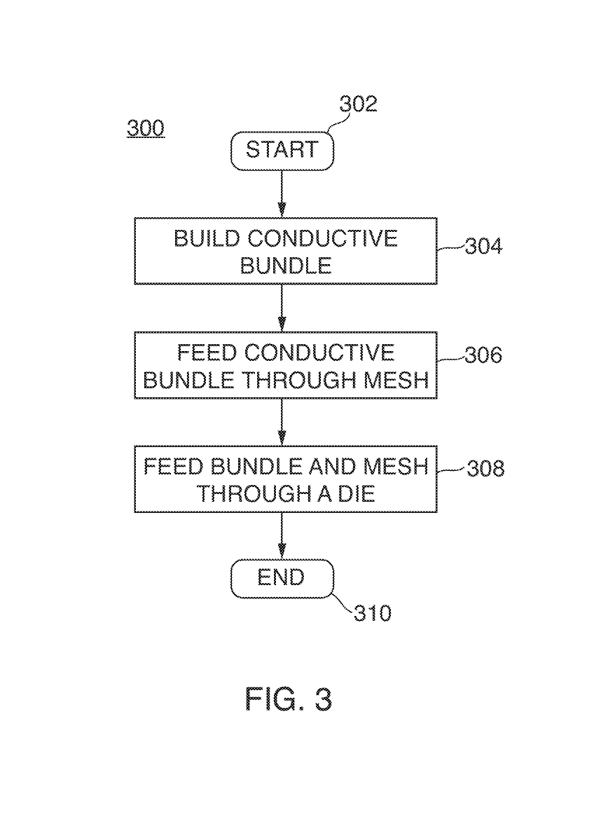

FIG. 3 is a flowchart of an illustrative process for manufacturing cable assemblies in accordance with some embodiments of the invention. Process 300 can begin at step 302. At step 304, the conductive bundle is assembled. This step should include placing conductors for signal conductors 102 and 104 and Vbus conductor 106 around filler 130, while at the same time providing ground elements 121, 123 and 125, such that proper spacing is maintained. Each of the individual components can be fed from a spool, and the assembled bundle could be collected on another spool for additional processing. At step 306, the assembled bundle can be fed through wire mesh 140, which should help to maintain the proper spacing for each of the individual components until outer jacket 150 is provided. It may be preferable to combine steps 304 and 306 into a single step, or as essentially two sub-steps to a single step.

At step 308, the assembled material can be extruded through the die to surround the conductor bundle, which is also passing through the die. The combination of the extruded material and conductor bundle form the assembled cable.

The described embodiments of the invention are presented for the purpose of illustration and not of limitation.

What is claimed is:

1. A cable assembly for use with electronic devices, the cable assembly comprising:
a plurality of signal conductors;
a voltage bus conductor;
a ground conductor comprising:
a first ground conductor element; and
a second ground conductor element physically separate from the first ground conductor element;
a wire mesh shield; and
a protective jacket encasing.

2. The cable assembly of claim 1, wherein the ground conductor further comprises:
a third ground conductor element physical separate from both the first and second ground conductor elements.

3. The cable assembly of claim 1, further comprising:
a central spacing component located along the axis of the cable assembly.

4. The cable assembly of claim 3, wherein the central spacing component comprises:
a load-bearing, insulating material.

5. The cable assembly of claim 1, wherein each of the plurality of signal conductors comprises:
an electrically conductive material; and
insulating material formed completely around the circumference of the conductive material, the insulating material comprising FEP.

6. The cable assembly of claim 1, wherein each of the plurality of signal conductors comprises:
a plurality of electrically conductive strands of wire tightly wound together; and
insulating material formed completely around the circumference of the conductive material.

7. The cable assembly of claim 1, wherein the voltage bus conductor comprises:
a plurality of electrically conductive strands of wire tightly wound together; and
insulating material formed completely around the circumference of the conductive material.

8. The cable assembly of claim 7, wherein the insulating material comprises:
FEP.

9. The cable assembly of claim 1, wherein the mesh shield comprises:
a plurality of electrically conductive wires formed in a crisscross weave such that the angle between crisscrossing conductors is at least twenty degrees.

10. The cable assembly of claim 9, wherein the angled between crisscrossing conductors is at least twenty-five degrees.

11. A method for constructing a cable structure, comprising:
forming a conductive bundle comprising:
a voltage bus conductor;
a plurality of signal conductors;
a ground conductor comprising at least first and second physically separate conductors;
feeding the conductive bundle through a wire mesh shield; and
extruding the conductive bundle and wire mesh shield with material.

12. The method of claim 11, wherein feeding the conductive bundle comprises:
forming a wire mesh shield by crisscrossing a plurality of individually conductive wires together such that the angle between crisscrossing wires is at least twenty degrees; and
inserting the conductive bundle through the crisscrossed wire mesh shield.

13. The method of claim 11, wherein the ground conductor further comprises:
at least a third electrically conductive element that is physically separate from the first and second separate conductors.

14. The method of claim 13, wherein forming further comprises:
locating each of the voltage bus conductor, first, second, and third ground conductors, and plurality of signal conductors substantially symmetrically about a filler component.
